(19) United States
(12) Patent Application Publication
(10) Pub. No.: US 2007/0005673 A1
(43) Pub. Date: Jan. 4, 2007

(54) The Creation and Detection of Binary and Non-Binary Pseudo-Noise Sequences Not Using LFSR Circuits

(76) Inventor: Peter Lablans, Morris Township, NJ (US)

Correspondence Address: DIEHL SERVILLA LLC, 77 BRANT AVE, SUITE 110, CLARK, NJ, 07066, US

(21) Appl. No.: 11/427,498

(22) Filed: Jun. 29, 2006

Related U.S. Application Data
(60) Provisional application No. 60/695,317, filed on Jun. 30, 2005.

(51) Int. Cl. G06F 7/58

(52) U.S. Cl. 708/250

(57) ABSTRACT

The invention discloses methods to create binary and non-binary sequences of a pseudo-random nature such that possible symbols occur at or almost at the same rate. The invention also discloses methods using symbol words of fixed lengths to generate unique sequences. These methods do not apply Linear Feedback Shift Registers (LFSRs). Methods to detect the presence of a pre-defined sequence are also disclosed. These methods do not apply LFSRs.

### CROSS-REFERENCE TO RELATED APPLICATIONS

This application claims the benefit of U.S. Provisional Patent Application Ser. No. 60/695,317, filed Jun. 30, 2005, which is incorporated herein by reference.

### BACKGROUND OF THE INVENTION

This invention relates to the creation of sequences comprised of binary or non-binary elements and the detection of sequences. More specifically it relates to applying other methods than the use of LFSR based sequence generators and descramblers.

Sequences comprised of digital elements have known applications in communications and other applications. In general binary pseudo-noise or PN-sequences are used. Application of non-binary sequences is also possible. Linear feedback shift register (LFSR) circuits or methods are often used for the generation and detection of sequences. LFSR circuits with p register elements can only generate (n^{p}−1) length unique n-valued sequences, while sometimes unique sequences of length n^{p} digits or elements are required. In applications where sequences have to be detected at very high clock rates the use of LFSRs may create an excessively high power-consumption. In those situations sequence detectors not using LFSRs may be desired.

Consequently, methods to generate and to detect digital sequences not using LFSR based methods are required.

### SUMMARY OF THE INVENTION

In view of the more limited possibilities of the prior art in creating and detecting binary and non-binary digital sequences devices, the current invention provides methods and apparatus for the creation and detection of sequences not using LFSRs.

The general purpose of the present invention, which will be described subsequently in greater detail, is to provide novel methods and apparatus which can be applied in the creation and detection of digital sequences with pseudo-noise or pseudo-noise like properties which can be used in applications such as spread-spectrum technology, wireless and UWB applications in telecommunications, performance and quality testing of communication channels and electronic circuits and security applications such as watermarking. Before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

Binary in the context of this application means 2-valued or 2-state. Binary logic functions are assumed to have two input values and one output value determined by a truth table, usually presented in a 2×2 matrix form, with input values shown in an additional row on top of the matrix and one column to the left of the matrix. The circuitry can be extended to additional inputs and outputs. Multi-valued in the context of this invention means an integer greater than 2.

One object of the present invention is to provide new methods and apparatus to create pseudo-noise sequences not applying LFSRs.

Another object of the present invention is to create binary sequences with an equal number of 0 and 1 bits and of a sequence length being a multiple of 2.

Another object of the present invention is to create binary sequences with an equal number or near equal number of 0 and 1 bits and which can be created by using binary words comprised of p bits only once, wherein p is an integer of 2 or greater.

Another object of the present invention is to create ternary pseudo-noise sequences or signals not using LFSRs.

Another object of the present invention is to create ternary sequences with an equal number of symbols or symbol representing signals representing the possible ternary states by using all ternary words of p ternary symbols only once, wherein p is an integer of 2 or greater.

Another object of the present invention is to create n-valued pseudo-noise like sequences or signals not using LFSRs.

Another object of the present invention is to create n-valued sequences with an equal number of symbols or symbol representing signals representing the possible n-valued states by using all n-valued words of p n-valued symbols only once, wherein p is an integer of 2 or greater.

Another object of the present invention is to detect binary sequences generated according to the aspects of the present invention, by using non-LFSR based methods or apparatus.

Another object of the present invention is to detect non-binary sequences generated according to the aspects of the present invention, by using non-LFSR based methods or apparatus.

### BRIEF DESCRIPTION OF THE DRAWINGS

Various other objects, features and attendant advantages of the present invention will become fully appreciated as the same becomes better understood when considered in conjunction with the accompanying drawings, and wherein:

FIG. 1 is a block diagram of a binary LFSR based sequence generator.

FIG. 2 is another block diagram of a binary LFSR based sequence generator.

FIG. 3 is another block diagram of a binary LFSR based sequence generator.

FIG. 4 is a 3-digit word binary ‘word table’ for generating a binary sequence.

FIG. 5 is a binary ‘word table’ describing a path and its states to generate a PN like sequence.

FIG. 6 shows a correlation graph.

FIG. 7 shows another correlation graph.

FIG. 8 shows a correlation graph.

FIG. 9 shows a correlation graph.

FIG. 10 shows another correlation graph.

FIG. 11 shows a correlation graph.

FIG. 12 shows a correlation graph.

FIG. 13 shows another correlation graph.

FIG. 14 shows a correlation graph.

FIG. 15 is a diagram of a sequence detection circuit.

FIG. 16 is a diagram of a 15-bits sequence detection circuit.

FIG. 17 is another diagram of a 15-bits sequence detection circuit.

FIG. 18 is another diagram of a sequence detection circuit.

FIG. 19 is another diagram of a sequence detection circuit.

FIG. 20 is a diagram of an n-valued sequence detection circuit.

### DETAILED DESCRIPTION OF THE INVENTION

The Related Art

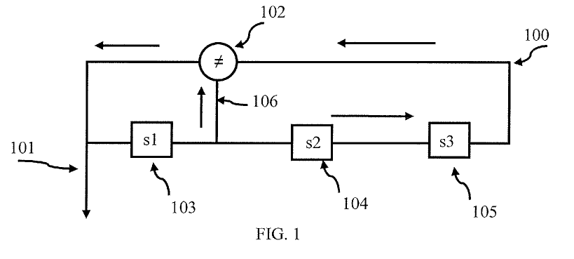

The generation of binary pseudo-noise sequences by way of LFSR based circuitry is well known. FIG. 1 shows as an illustrative example a known configuration of a binary LFSR based sequence generator 100. The LFSR comprises three shift register elements 103, 104 and 105. The generator has an output 101 which will provide the generated sequence. A feedback tap 106 provides the signal on output of element 103 to a first input of device 102. The output signal of element 105 is provided to a second input of 102. Device 102 executes the XOR or modulo-2 addition function. The generator is under control of a (not shown but assumed) clock signal. At the occurrence of the clock signal the content of an element of the shift register is moved one position to the element on its right, except the content of the last element, which will be lost.

The sequence generator works completely independent of external inputs as long as a relevant clock signal is available. The only condition is that the initial content of the shift register should not be [0 0 0], as under that condition no transition will occur and the signal on output 101 will remain 0 all the time.

State Dependent Generation Method for Binary Sequences.

The theoretical basis for designing LFSR based binary sequence generators is known. It applies primitive or irreducible polynomials of degree p over GF(2), wherein p is the number of shift register elements. It is known that an LFSR based sequence generator can create a sequence that is unique in its order of bits and composition of a maximum length of 2^{p}−1. After that number of bits the sequence will start repeating itself. In the example of FIG. 1 the maximum length of the generated sequence is (2³−1=7).

Another property of the sequence generated by the circuit of FIG. 1 is that each maximum length sequence generated by this circuit depends on the initial content of the shift register. Assuming that initial content [0 0 0] will not occur, under every other initial content of the shift register a maximum length sequence will be generated which all will be cyclical variants of each other. A different way to say this is that all sequences generated by the generator of FIG. 1 depend on the initial content of the shift register and reflect the consecutive contents of the shift register. This is shown in the following table, starting with initial content [0 0 1].

| | | | | | s1 | s2 | s3 |
|---|---|---|---|---|---|---|---|
| out1 | 1 | 1 | 0 | 1 | 0 | 0 | 1 |
| out2 | 0 | 1 | 1 | 1 | 0 | 1 | 0 |
| out3 | 1 | 0 | 1 | 0 | 0 | 1 | 1 |
| out4 | 1 | 1 | 1 | 0 | 1 | 0 | 0 |
| out5 | 0 | 0 | 1 | 1 | 1 | 0 | 1 |
| out6 | 1 | 0 | 0 | 1 | 1 | 1 | 0 |
| out7 | 0 | 1 | 0 | 0 | 1 | 1 | 1 |

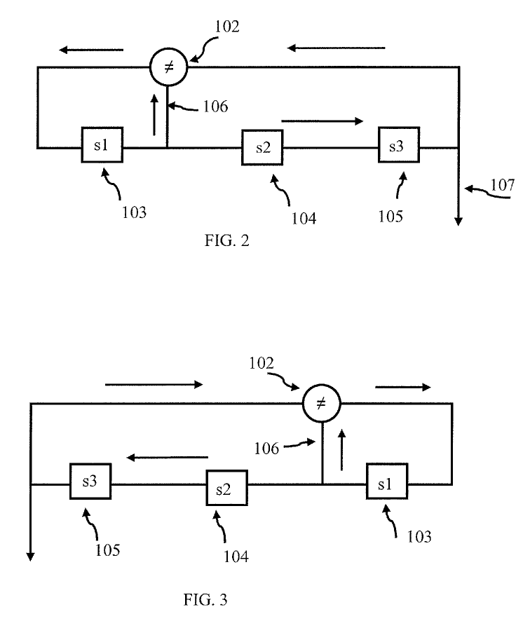

The content of the shift register is shown in the table under columns s1, s2 and s3. The rows of the table show the output signal or sequence on 101. All rows are cyclical versions of each other. The content of the shift register shows up at the end of the sequence. FIG. 2 shows the same configuration as in FIG. 1, but the output of the circuit is now 107. So the content of the shift register is first pushed out and shows up first in the output sequence on 107. This is shown in the following table.

| | s1 | s2 | s3 | | | | |
|---|---|---|---|---|---|---|---|
| out1 | 0 | 0 | 1 | 1 | 1 | 0 | 1 |
| out2 | 0 | 1 | 0 | 0 | 1 | 1 | 1 |
| out3 | 0 | 1 | 1 | 1 | 0 | 1 | 0 |
| out4 | 1 | 0 | 0 | 1 | 1 | 1 | 0 |
| out5 | 1 | 0 | 1 | 0 | 0 | 1 | 1 |
| out6 | 1 | 1 | 0 | 1 | 0 | 0 | 1 |
| out7 | 1 | 1 | 1 | 0 | 1 | 0 | 0 |

The content of the shift register is shown in numerical order. This can be re-arranged into actual consecutive content and is shown in the following table.

| | s1 | s2 | s3 | | | | |
|---|---|---|---|---|---|---|---|
| out1 | 0 | 0 | 1 | 1 | 1 | 0 | 1 |
| out4 | 1 | 0 | 0 | 1 | 1 | 1 | 0 |
| out2 | 0 | 1 | 0 | 0 | 1 | 1 | 1 |
| out5 | 1 | 0 | 1 | 0 | 0 | 1 | 1 |
| out6 | 1 | 1 | 0 | 1 | 0 | 0 | 1 |
| out7 | 1 | 1 | 1 | 0 | 1 | 0 | 0 |
| out3 | 0 | 1 | 1 | 1 | 0 | 1 | 0 |

It seems like the sequence with each consecutive step is moved one position to the right. For easier analysis it is more convenient to make the sequence appear to move to the left. This is achieved by ‘folding’ the circuit as shown in FIG. 3. It does not change the working of the circuit, but it changes how the output sequence on 108 is represented. This is shown in the following table.

| | s3 | s2 | s1 | | | | |
|---|---|---|---|---|---|---|---|
| out1 | 0 | 0 | 1 | 1 | 1 | 0 | 1 |
| out3 | 0 | 1 | 1 | 1 | 0 | 1 | 0 |
| out7 | 1 | 1 | 1 | 0 | 1 | 0 | 0 |
| out6 | 1 | 1 | 0 | 1 | 0 | 0 | 1 |
| out5 | 1 | 0 | 1 | 0 | 0 | 1 | 1 |
| out2 | 0 | 1 | 0 | 0 | 1 | 1 | 1 |
| out4 | 1 | 0 | 0 | 1 | 1 | 1 | 0 |

FIG. 1, FIG. 2 and FIG. 3 show identical circuits; for this reason the circuits use identical numerals for components that execute the same functions in the diagrams of FIG. 1, FIG. 2 and FIG. 3. Another way to show the output signals is shown in the following table.

| | s3 | s2 | s1 | | | | | | | | | | |
|---|---|---|---|---|---|---|---|---|---|---|---|---|---|
| out1 | 0 | 0 | 1 | 1 | 1 | 0 | 1 | | | | | | |
| out3 | | 0 | 1 | 1 | 1 | 0 | 1 | 0 | | | | | |
| out7 | | | 1 | 1 | 1 | 0 | 1 | 0 | 0 | | | | |
| out6 | | | | 1 | 1 | 0 | 1 | 0 | 0 | 1 | | | |
| out5 | | | | | 1 | 0 | 1 | 0 | 0 | 1 | 1 | | |
| out2 | | | | | | 0 | 1 | 0 | 0 | 1 | 1 | 1 | |
| out4 | | | | | | | 1 | 0 | 0 | 1 | 1 | 1 | 0 |

The table can be interpreted as follows: the two elements [s2 s1] in the previous state of the shift register are the first two elements [s3 s2] of the new state of the shift register. In fact a new method for the generation of pseudo-random sequences using a state-machine solution is derived from this observation and is one aspect of the present invention.

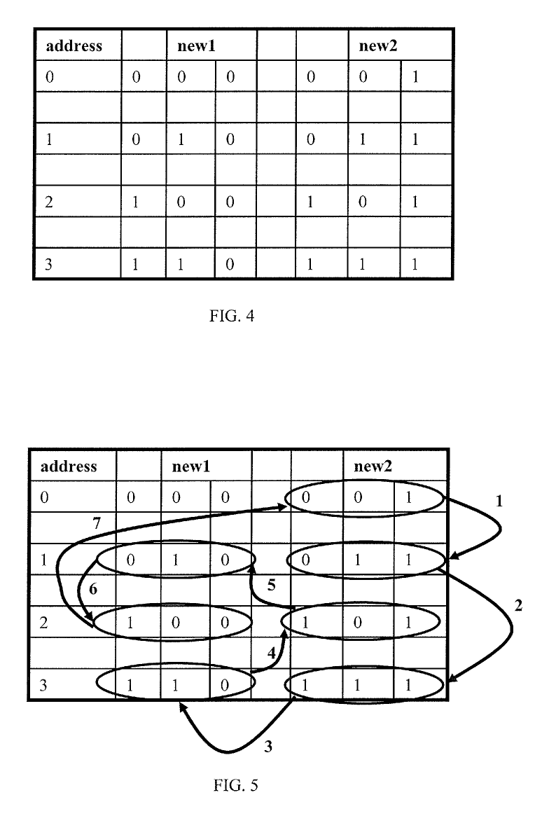

This method is explained in an illustrative example for the above table in FIG. 4 and FIG. 5. FIG. 4 has all possible 3 bits words arranged in a table in such a way that the first two bits of a word are assumed to indicate the row the word will be in. So both word [1 0 0] and word [1 0 1] are in row [1 0] or row 2, when it is assumed to be working from origin 0. The third bit determines the column the word is put in. So word [1 0 0] is put in column 0 and word [1 0 1] is put in column 1.

The last two bits of a word are to be considered the address of the next word. So word [1 0 0] can point to word [0 0 0] or word [0 0 1]. As word [0 0 0] is forbidden, it has to point to word [0 0 1]. It should be clear that there are different ways to go from a current state to a next state. Some states will create dead ends, as each word should be used just once to achieve pseudo-random results. A computer program can be used to follow all possible paths.

The current example in FIG. 5 starts at word [0 0 1]. It points to a new word in row [0 1] and [0 1 1] is selected via path 1. Path 2 goes to word [1 1 1]. Path 3 goes to word [1 1 0]. Path 4 goes to [1 0 1]. Path 5 goes to [0 1 0]; and path 6 goes to [1 0 0]. Path 7 takes it back again to word [0 0 1]. The generated sequence is formed by the first bit of the words in the path: [0 0 1 1 1 0 1]. This is a PN-sequence.

The formal method to create pseudo-random binary sequences of length 2^{p}−1 comprises the following steps:

1. assume a word length of p bits;

2. create all possible binary words of p bits;

3. arrange the words in tables such that the first (p−1) bits indicate the row they are in;

3. assume the word with all 0s to be not usable and a ‘forbidden’ word;

4. start a PN table wherein the first word is comprised of p 1s;

5. complete all PN tables following the path wherein the first (p−1) bits of a word have the last (p−1) bits of the previous word in common;

6. each word can only be used once;

7. follow a path such that always the first utmost left, not yet in a path included word in a row is used in a path;

8. a sequence is completed successfully when all allowed words have been used once;

9. a sequence is formed by the first bits of the words, in the order of the achieved path;

10. rearrange all words in a word table in such a way that one word in any row assumes a possible column position it has not previously assumed and start at step 3 again;

11. repeat above steps until all unique word tables have been used;

12. repeat steps 1 to 10 wherein the word with all 1s is ‘forbidden’ and the all 0 word is the starting word;

One can of course start the process with any word of length p as long as the ‘forbidden word’ is excluded from the process.

The process as described above allows to create all possible binary PN sequences;

The first bits of the words in a path of the table are the generated sequences. Often certain statistical properties, reflected in for instance the auto-correlation of a sequence, or cross-correlation between sequences are desirable. A well known criterion is a bi-level auto-correlation, wherein the auto-correlation of a sequence shows a high center peak and a constant low value (0 or less than 0 for off-center).

As an illustrative example the method will be demonstrated for binary words of length 3, for which the sequences will have a length of 7 bits. This solution starts with the described method using [0 0 0] as forbidden word.

| | b1 | b2 | b3 | | | | | | | |
|---|---|---|---|---|---|---|---|---|---|---|
| word1 | 1 | 1 | 1 | | | | | | | |
| word2 | | 1 | 1 | 0 | | | | | | |
| word3 | | | 1 | 0 | 1 | | | | | |
| word4 | | | | 0 | 1 | 0 | | | | |
| word5 | | | | | 1 | 0 | 0 | | | |
| word6 | | | | | | 0 | 0 | 1 | | |
| word7 | | | | | | | 0 | 1 | 1 | |
| word1 | | | | | | | | 1 | 1 | 1 |
| sequence | 1 | 1 | 1 | 0 | 1 | 0 | 0 | | | |

Another solution with [0 0 0] as forbidden word:

| | b1 | b2 | b3 | | | | | | | |
|---|---|---|---|---|---|---|---|---|---|---|
| word1 | 1 | 1 | 1 | | | | | | | |
| word2 | | 1 | 1 | 0 | | | | | | |
| word3 | | | 1 | 0 | 0 | | | | | |
| word4 | | | | 0 | 0 | 1 | | | | |
| word5 | | | | | 0 | 1 | 0 | | | |
| word6 | | | | | | 1 | 0 | 1 | | |
| word7 | | | | | | | 0 | 1 | 1 | |
| word1 | | | | | | | | 1 | 1 | 1 |
| sequence | 1 | 1 | 1 | 0 | 0 | 1 | 0 | | | |

Another solution with [1 1 1] as forbidden word:

| | b1 | b2 | b3 | | | | | | | |
|---|---|---|---|---|---|---|---|---|---|---|
| word1 | 0 | 0 | 0 | | | | | | | |
| word2 | | 0 | 0 | 1 | | | | | | |
| word3 | | | 0 | 1 | 0 | | | | | |
| word4 | | | | 1 | 0 | 1 | | | | |
| word5 | | | | | 0 | 1 | 1 | | | |
| word6 | | | | | | 1 | 1 | 0 | | |
| word7 | | | | | | | 1 | 0 | 0 | |
| word1 | | | | | | | | 0 | 0 | 0 |
| sequence | 0 | 0 | 0 | 1 | 0 | 1 | 1 | | | |

Another solution with [1 1 1] as forbidden word.

| | b1 | b2 | b3 | | | | | | | |
|---|---|---|---|---|---|---|---|---|---|---|
| word1 | 0 | 0 | 0 | | | | | | | |
| word2 | | 0 | 0 | 1 | | | | | | |
| word3 | | | 0 | 1 | 1 | | | | | |
| word4 | | | | 1 | 1 | 0 | | | | |
| word5 | | | | | 1 | 0 | 1 | | | |
| word6 | | | | | | 0 | 1 | 0 | | |
| word7 | | | | | | | 1 | 0 | 0 | |
| word1 | | | | | | | | 0 | 0 | 0 |
| sequence | 0 | 0 | 0 | 1 | 1 | 0 | 1 | | | |

The two solutions with [0 0 0] as forbidden word are the known binary sequences which can be generated by the LFSRs according to irreducible polynomials: X³+X+1 and X³+X²+1. The creation of the sequences according to one aspect of the present invention allows for tables to be applied from top-to-bottom and from bottom-to-top. This explains the two sequences: one created from top-to-bottom. The second sequence with forbidden word [0 0 0] can be created from the first sequence by ‘reading it backwards’. The two sequences are each others mirror image.

The two solutions with [1 1 1] as forbidden word can also be created from the first two solutions by inverting all 0s and 1s. This means that the sequences with [1 1 1] can be also created with LFSRs wherein the XOR function is replaced by an EQUAL function.

One can also create pseudo-random like binary sequences of length 8 by applying the 3-bit method word and not having a forbidden word. The thus generated sequences are: [0 0 0 1 0 1 1 1] and [0 0 0 1 1 1 0 1].

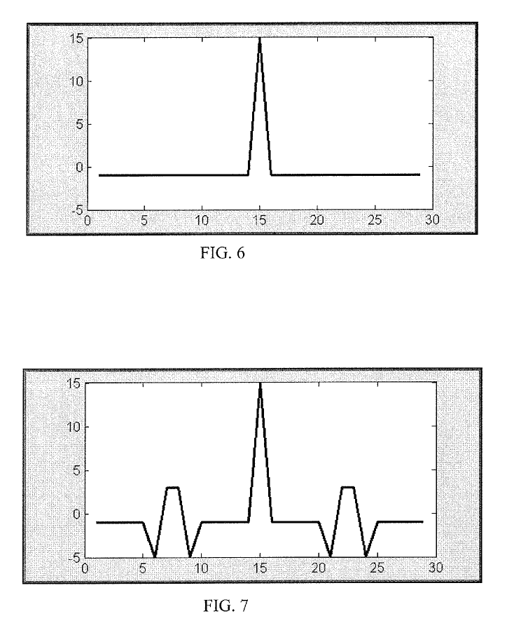

In many cases the generated sequences according to the method will be cyclical versions of each other. Another aspect of the present invention is to check if sequences are cyclical versions of each other. A computer program can be developed to perform such a check. Using 4-bits words and [0 0 0 0] as the forbidden state one can find 32 completed paths and sequences of 15 bits. Of these sequences 3 (which can also be found with Finite Field theory) are maximum-length sequences with a bi-level auto-correlation graph. The auto-correlation graph is shown in FIG. 6. One of these 15 bits PN sequences is: [1 1 1 1 0 1 0 1 1 0 0 1 0 0 0]. One of the other 29 sequences has an auto-correlation graph as shown in FIG. 7. This sequence of 15 bits is: [1 1 1 1 0 1 0 0 0 1 1 0 0 1 0].

Sequences Generated by 4-Bit and 5-Bit Words

The word based methods can be expanded to create binary sequences with a 2^{p} length using p-bits words. The thus generated sequences will be of a pseudo-noise nature, having equal numbers of 0s and 1s. For instance by using the method with 4-bits words and having no forbidden word, one can create 16 sequences of length 16. An example thereof is provided in the following table, showing 8 of the 16 sequences.

| | 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|---|
| seq1 | 1 | 1 | 1 | 1 | 0 | 1 | 0 | 0 | 0 | 0 | 1 | 1 | 0 | 0 | 1 | 0 |
| seq2 | 1 | 1 | 1 | 1 | 0 | 0 | 1 | 1 | 0 | 1 | 0 | 0 | 0 | 0 | 1 | 0 |
| seq3 | 1 | 1 | 1 | 1 | 0 | 1 | 0 | 0 | 1 | 1 | 0 | 0 | 0 | 0 | 1 | 0 |
| seq4 | 1 | 1 | 1 | 1 | 0 | 0 | 0 | 0 | 1 | 0 | 0 | 1 | 1 | 0 | 1 | 0 |
| seq5 | 1 | 1 | 1 | 1 | 0 | 1 | 0 | 0 | 0 | 0 | 1 | 0 | 1 | 1 | 0 | 0 |
| seq6 | 1 | 1 | 1 | 1 | 0 | 0 | 0 | 0 | 1 | 0 | 1 | 0 | 0 | 1 | 1 | 0 |
| seq7 | 1 | 1 | 1 | 1 | 0 | 1 | 0 | 1 | 1 | 0 | 0 | 1 | 0 | 0 | 0 | 0 |
| seq8 | 1 | 1 | 1 | 1 | 0 | 1 | 1 | 0 | 0 | 1 | 0 | 1 | 0 | 0 | 0 | 0 |

The next table shows sequence how ‘seq8’ with a length of 16 bits can be created using the method described and 4-bits words wherein the last three bits of a word will be equal to the first three bits of the next word, and using all possible 4-bits words without repeating any word.

| | b1 | b2 | b3 | b4 | | | | | | | | | | | | | | | |
|---|---|---|---|---|---|---|---|---|---|---|---|---|---|---|---|---|---|---|---|
| word1 | 1 | 1 | 1 | 1 | | | | | | | | | | | | | | | |
| word2 | | 1 | 1 | 1 | 0 | | | | | | | | | | | | | | |
| word3 | | | 1 | 1 | 0 | 1 | | | | | | | | | | | | | |
| word4 | | | | 1 | 0 | 1 | 1 | | | | | | | | | | | | |
| word5 | | | | | 0 | 1 | 1 | 0 | | | | | | | | | | | |
| word6 | | | | | | 1 | 1 | 0 | 0 | | | | | | | | | | |
| word7 | | | | | | | 1 | 0 | 0 | 1 | | | | | | | | | |
| word8 | | | | | | | | 0 | 0 | 1 | 0 | | | | | | | | |
| word9 | | | | | | | | | 0 | 1 | 0 | 1 | | | | | | | |
| word10 | | | | | | | | | | 1 | 0 | 1 | 0 | | | | | | |
| word11 | | | | | | | | | | | 0 | 1 | 0 | 0 | | | | | |
| word12 | | | | | | | | | | | | 1 | 0 | 0 | 0 | | | | |
| word13 | | | | | | | | | | | | | 0 | 0 | 0 | 0 | | | |
| word14 | | | | | | | | | | | | | | 0 | 0 | 0 | 1 | | |
| word15 | | | | | | | | | | | | | | | 0 | 0 | 1 | 1 | |
| word16 | | | | | | | | | | | | | | | | 0 | 1 | 1 | 1 |
| seq8 | 1 | 1 | 1 | 1 | 0 | 1 | 1 | 0 | 0 | 1 | 0 | 1 | 0 | 0 | 0 | 0 | | | |

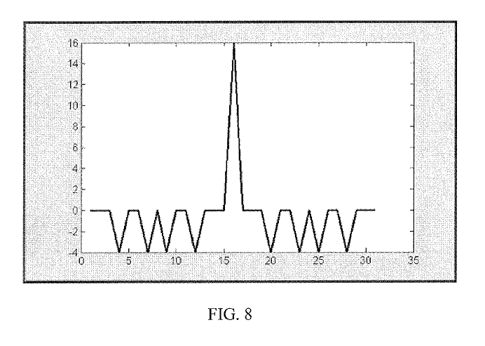

FIG. 8 shows the auto-correlation graph for the 16 bit sequence as generated in the above table. The auto-correlation has three values: a peak value at the center of the graph and two values, one equal to 0 and one less than zero off-center. All of the sequences ‘seq1’ to ‘seq8’ are different sequences of 16-bit length but have a similar auto-correlation graph can be generated with the method here provided. Also 16-bits sequences having different (and not 3-valued) auto-correlation graphs can be generated.

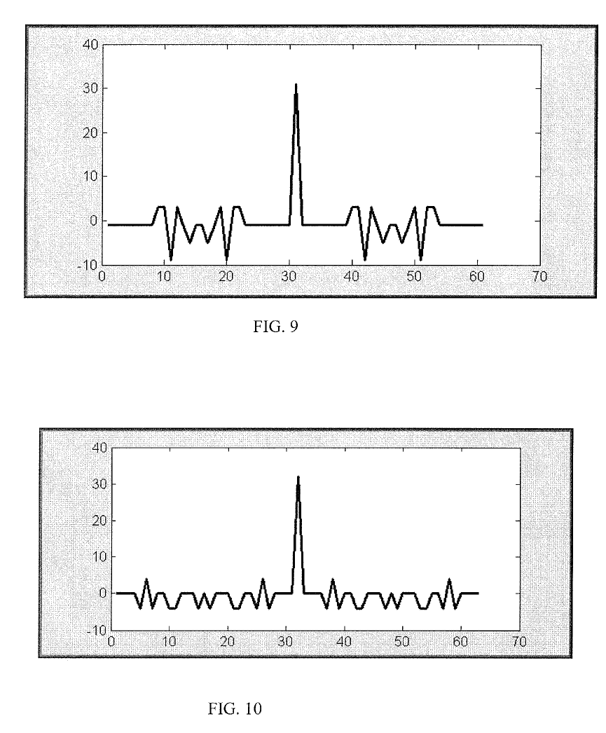

As another example the method has been applied using 5-bit words. This generates thousands of sequences of length of 31 bits of which 6 sequences are the known 31 bit PN sequences with bi-level auto-correlation. One can also generate thousands of pseudo-random like binary sequences of length 31 bits with fairly decent auto-correlation properties. One example is: [1 1 1 1 1 0 0 0 1 0 1 0 0 1 0 0 0 0 1 1 1 0 1 1 0 0 1 1 0 1 0]. The auto-correlation graph of this sequence is shown in FIG. 9.

One can also generate 32 bits PN-like sequences by using the method of 5-bits words. One of those sequences is: [1 1 1 1 1 0 0 0 1 1 1 0 1 1 0 0 1 1 0 1 0 0 1 0 0 0 0 0 1 0 1 0] of which the auto-correlation graph is shown in FIG. 10. It is clear that this sequence contains the words [0 0 0 0 0] and [1 1 1 1 1].

This shows that the concept of ‘forbidden’ word in the novel method can have a different meaning than in LFSR based methods. In LFSR based methods a “forbidden” word indicates that the LFSR with the shift register containing that word will get stuck in generating identical symbols or bits. In the method of this invention a ‘forbidden’ word is a word that is excluded from a sequence generating path.

The following example shows how a 15-bits sequence can be generated using this method and using both [0 0 0 0] and [1 1 1 1] of which one is a ‘forbidden’ word when using LFSR methods. The sequence is:

seq15=[0 0 1 1 1 1 0 1 0 0 0 0 1 0 1]. The generating table is shown in the following table.

| | b1 | b2 | b3 | b4 | | | | | | | | | | | | | | |
|---|---|---|---|---|---|---|---|---|---|---|---|---|---|---|---|---|---|---|
| word1 | 0 | 0 | 1 | 1 | | | | | | | | | | | | | | |
| word2 | | 0 | 1 | 1 | 1 | | | | | | | | | | | | | |
| word3 | | | 1 | 1 | 1 | 1 | | | | | | | | | | | | |
| word4 | | | | 1 | 1 | 1 | 0 | | | | | | | | | | | |
| word5 | | | | | 1 | 1 | 0 | 1 | | | | | | | | | | |
| word6 | | | | | | 1 | 0 | 1 | 0 | | | | | | | | | |
| word7 | | | | | | | 0 | 1 | 0 | 0 | | | | | | | | |
| word8 | | | | | | | | 1 | 0 | 0 | 0 | | | | | | | |
| word9 | | | | | | | | | 0 | 0 | 0 | 0 | | | | | | |
| word10 | | | | | | | | | | 0 | 0 | 0 | 1 | | | | | |
| word11 | | | | | | | | | | | 0 | 0 | 1 | 0 | | | | |
| word12 | | | | | | | | | | | | 0 | 1 | 0 | 1 | | | |
| word13 | | | | | | | | | | | | | 1 | 0 | 1 | 1 | | |
| word14 | | | | | | | | | | | | | | 0 | 1 | 1 | 0 | |
| word15 | | | | | | | | | | | | | | | 1 | 1 | 0 | 0 |
| seq15 | 0 | 0 | 1 | 1 | 1 | 1 | 0 | 1 | 0 | 0 | 0 | 0 | 1 | 0 | 1 | | | |

The sequence is generated by 15 different words. The ‘forbidden’ or rather not used word is [1 0 0 1]. This sequence (and there are others) has no equivalent in LFSR based solutions. Further more under the rules of exclusivity ‘word14’ and ‘word15’ are ‘disconnected’ from ‘word1’. This sequence cannot be cyclically generated from previous states. It should be clear that this method of “disconnected” start and ending words applies to binary sequences generated by words of other lengths as well to the generation of non-binary sequences.

Non-Binary Sequences

According to another aspect of the present invention it is also possible to generate non-binary sequences with the method of this invention. The way to do that is by using p-digit words of n-valued elements. The words with p elements can assume more values than in the binary case. A word of p elements in an n-valued logic can assume n^{p} different values. The n-valued pseudo-noise sequence generated by an LFSR is then n^{p}−1 elements long. The methods and apparatus to generate n-valued pseudo-noise sequences with attractive correlation properties by using LFSRs have been described in United States Non-Provisional patent application Ser. No. 10/935,960, filed on Sep. 8, 2004, entitled TERNARY AND MULTI-VALUE DIGITAL SCRAMBLERS, DESCRAMBLERS AND SEQUENCE GENERATORS which is hereby incorporated by reference.

Illustrative examples will be provided to explain using the ‘p-digit word’ method for creating non-binary pseudo-noise like sequences of length n^{p}−1. The steps to be applied are the following:

1. use an n-valued logic with n an integer greater than 2;

2. create all n^{p} digital words of p n-valued elements, with p an integer greater than 1;

3. select one of the words comprised of identical elements as a ‘not-used’ or forbidden word;

4. create a ‘word table’ wherein each row contains the words with identical first (p−1) elements;

5. start a PN table wherein the first word is not the forbidden word;

6. complete the PN tables following the path wherein the first (p−1) bits of a next word have the last (p−1) bits of the previous word in common;

7. each word can only be used once;

8. a path is completed when (p−1) different words have been used. The sequence is formed by the first digit of each word.

Different sequences can be formed by creating a new ‘word table’ by changing the position of one of the words in a word table and completing the steps of the method.

One can use different ‘forbidden words’. Some of the sequences will end with a word that connects according to the above rules with the first word of the PN table. The sequences thus formed are cyclical and may be formed by LFSR type solutions also. One can of course start the process with any word of length p as long as the ‘forbidden word’ is excluded from the process. The length of a sequence will be (n^{p}−1) digits.

It should be clear that there are many different paths that can be followed in the above method to complete an n-valued sequence. As the word length increases the number of possible paths increases exponentially.

One can also create n-valued sequences of length n^{p} digits by using all p-digit words.

Generating Ternary Sequences

According to one aspect of the present invention and as an illustrative example ternary sequences of length 8 using 2-digit ternary words will be created.

The process starts out by creating ‘word tables’ of 2 elements ternary words. Three ‘word tables’ are shown in the following table.

| address | ‘word table 1’ | | | | | | ‘word table 2’ | | | | | | ‘word table 3’ | | | | | |
|---|---|---|---|---|---|---|---|---|---|---|---|---|---|---|---|---|---|---|
| 0 | 0 | 0 | 0 | 1 | 0 | 2 | 0 | 0 | 0 | 2 | 0 | 1 | 0 | 1 | 0 | 0 | 0 | 2 |
| 1 | 1 | 0 | 1 | 1 | 1 | 2 | 1 | 0 | 1 | 1 | 1 | 2 | 1 | 0 | 1 | 1 | 1 | 2 |
| 2 | 2 | 0 | 2 | 1 | 2 | 2 | 2 | 0 | 2 | 1 | 2 | 2 | 2 | 0 | 2 | 1 | 2 | 2 |

In order to computerize the generation of different sequences by using different paths it is the easiest to use a procedure wherein a path uses the next ‘un-used’ word in a row. For instance assume that the last word was [2 0]. According to the method the next word has to start with the last element of the last word, which was a 0. So the next word has to be in row with address 0. If no word from row 0 was used before then the first usable word in the row with address 0 in ‘word table 1’ is [0 0], it is also [0 0] in ‘word table 2’ and [0 1] in ‘word table 3’. This assumes of course that [0 0] is not a forbidden word. Consequently different ‘word tables’ enable the creation of different paths and sequences. One can say that a certain ‘world table’ enables a specific sequence.

The three different columns in a ‘word table’ can create 3!=6 different rows with address 0, but with different arrangements of words. Consequently there are 6×6×6=216 different ‘word tables’ and possible different paths. Some paths however may be ‘dead-ends’ and not be able to be completed. Starting from the first word of the first row of all possible ‘word tables’ one can generate at least 144 sequences of ternary symbols of length 8.

One of the generated sequences is [0 0 1 0 2 2 1 2], which has a bi-level auto-correlation graph with a single peak. The used ‘word table’ is shown in the following table:

| address | | new1 | | new2 | | new3 |
|---|---|---|---|---|---|---|
| 0 | 0 | 0 | 0 | 1 | 0 | 2 |
| 1 | 1 | 0 | 1 | 2 | 1 | 1 |
| 2 | 2 | 2 | 2 | 1 | 2 | 0 |

The following ternary PN table shows how the sequence is generated.

| | | | | | | | | | |
|---|---|---|---|---|---|---|---|---|---|
| word1 | 0 | 0 | | | | | | | |
| word2 | | 0 | 1 | | | | | | |
| word3 | | | 1 | 0 | | | | | |
| word4 | | | | 0 | 2 | | | | |
| word5 | | | | | 2 | 2 | | | |
| word6 | | | | | | 2 | 1 | | |
| word7 | | | | | | | 1 | 2 | |
| word8 | | | | | | | | 2 | 0 |

The process is started with [0 0]. The next address is the second digit of the word, which is 0. The next word is then the next un-used word in the row with address 0 in the ‘word table’. This is [0 1]. The next word has address 1. So the next word is the first un-used word in row 1 of the ‘word table’. This is word [1 0]. Etc. The word [1 1] is the forbidden word in this example. The last word in the table is word8=[2 0] and consequently the process can start all over again to generate the same sequence.

Another example is the ternary sequence [0 1 0 2 2 1 1 2] generated by the following ‘word table’.

| address | | new1 | | new2 | | new3 |
|---|---|---|---|---|---|---|
| 0 | 0 | 1 | 0 | 2 | 0 | 0 |
| 1 | 1 | 0 | 1 | 1 | 1 | 2 |
| 2 | 2 | 2 | 2 | 1 | 2 | 0 |

The word [0 0] is the ‘forbidden’ word in this example.

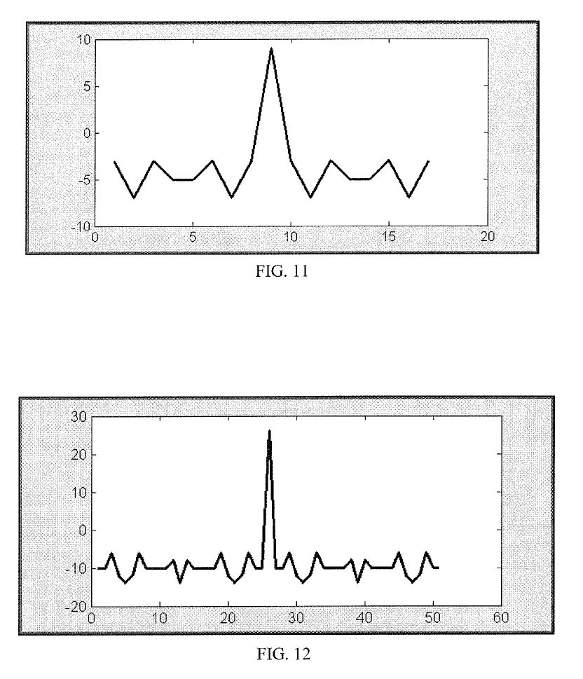

It is also possible to apply the method to generate 9-digit pseudo-noise like ternary sequences using 2-digit ternary ‘word tables’. One example is the sequence: [0 0 1 1 2 2 0 2 1]. The auto-correlation graph of this sequence is shown in FIG. 11. The sequence generating table is shown in the following table.

| | | | | | | | | | | |
|---|---|---|---|---|---|---|---|---|---|---|
| word1 | 0 | 0 | | | | | | | | |
| word2 | | 0 | 1 | | | | | | | |
| word3 | | | 1 | 1 | | | | | | |
| word4 | | | | 1 | 2 | | | | | |
| word5 | | | | | 2 | 2 | | | | |
| word6 | | | | | | 2 | 0 | | | |
| word7 | | | | | | | 0 | 2 | | |
| word8 | | | | | | | | 2 | 1 | |
| word9 | | | | | | | | | 1 | 0 |
| seq9 | 0 | 0 | 1 | 1 | 2 | 2 | 0 | 2 | 1 | |

This example has of course no ‘forbidden’ word.

Another illustrative example for generated ternary sequences is the use of 3-digit ternary words and related ‘word tables’.

One example of a 3-digit ternary ‘word table’ is provided in the following table.

| address | | new1 | | | new2 | | | new3 | |
|---|---|---|---|---|---|---|---|---|---|
| 00 | 0 | 0 | 0 | 0 | 0 | 1 | 0 | 0 | 2 |
| 01 | 0 | 1 | 0 | 0 | 1 | 1 | 0 | 1 | 2 |
| 02 | 0 | 2 | 0 | 0 | 2 | 1 | 0 | 2 | 2 |
| 10 | 1 | 0 | 0 | 1 | 0 | 1 | 1 | 0 | 2 |
| 11 | 1 | 1 | 0 | 1 | 1 | 1 | 1 | 1 | 2 |
| 12 | 1 | 2 | 0 | 1 | 2 | 1 | 1 | 2 | 2 |
| 20 | 2 | 0 | 0 | 2 | 0 | 1 | 2 | 0 | 2 |
| 21 | 2 | 1 | 0 | 2 | 1 | 1 | 2 | 1 | 2 |
| 22 | 2 | 2 | 0 | 2 | 2 | 1 | 2 | 2 | 2 |

The addresses of the 3-digit words are now comprised of 2 digits. This means that there are 6⁹ different ternary 3-digit ‘word tables’. The process of generating sequences can be computerized and over 300,000 sequences can be generated of which 9 have a bi-level auto-correlation graph with one peak.

One example of a thus generated sequence of length 26 is: [0 0 0 1 0 1 1 1 2 0 2 0 0 2 1 0 2 2 0 1 2 1 2 2 1 1]. The ‘word table’ that will generate this sequence is provided in the following table.

| address | | new1 | | | new2 | | | new3 | |
|---|---|---|---|---|---|---|---|---|---|
| 00 | 0 | 0 | 0 | 0 | 0 | 1 | 0 | 0 | 2 |
| 01 | 0 | 1 | 0 | 0 | 1 | 1 | 0 | 1 | 2 |
| 02 | 0 | 2 | 0 | 0 | 2 | 1 | 0 | 2 | 2 |
| 10 | 1 | 0 | 0 | 1 | 0 | 1 | 1 | 0 | 2 |
| 11 | 1 | 1 | 0 | 1 | 1 | 1 | 1 | 1 | 2 |
| 12 | 1 | 2 | 0 | 1 | 2 | 1 | 1 | 2 | 2 |
| 20 | 2 | 0 | 2 | 2 | 0 | 0 | 2 | 0 | 1 |
| 21 | 2 | 1 | 1 | 2 | 1 | 0 | 2 | 1 | 2 |
| 22 | 2 | 2 | 2 | 2 | 2 | 1 | 2 | 2 | 0 |

The ternary 26 digit sequence generating PN table is provided in the following table. Its auto-correlation graph is provided in FIG. 12.

| | | | | | | | | | | | | | | | | | | | | | | | | | | | | |
|---|---|---|---|---|---|---|---|---|---|---|---|---|---|---|---|---|---|---|---|---|---|---|---|---|---|---|---|---|
| word1 | 0 | 0 | 0 | | | | | | | | | | | | | | | | | | | | | | | | | |
| word2 | | 0 | 0 | 1 | | | | | | | | | | | | | | | | | | | | | | | | |
| word3 | | | 0 | 1 | 0 | | | | | | | | | | | | | | | | | | | | | | | |
| word4 | | | | 1 | 0 | 1 | | | | | | | | | | | | | | | | | | | | | | |
| word5 | | | | | 0 | 1 | 1 | | | | | | | | | | | | | | | | | | | | | |
| word6 | | | | | | 1 | 1 | 1 | | | | | | | | | | | | | | | | | | | | |
| word7 | | | | | | | 1 | 1 | 2 | | | | | | | | | | | | | | | | | | | |
| word8 | | | | | | | | 1 | 2 | 0 | | | | | | | | | | | | | | | | | | |
| word9 | | | | | | | | | 2 | 0 | 2 | | | | | | | | | | | | | | | | | |
| word10 | | | | | | | | | | 0 | 2 | 0 | | | | | | | | | | | | | | | | |
| word11 | | | | | | | | | | | 2 | 0 | 0 | | | | | | | | | | | | | | | |
| word12 | | | | | | | | | | | | 0 | 0 | 2 | | | | | | | | | | | | | | |
| word13 | | | | | | | | | | | | | 0 | 2 | 1 | | | | | | | | | | | | | |
| word14 | | | | | | | | | | | | | | 2 | 1 | 0 | | | | | | | | | | | | |
| word15 | | | | | | | | | | | | | | | 1 | 0 | 2 | | | | | | | | | | | |
| word16 | | | | | | | | | | | | | | | | 0 | 2 | 2 | | | | | | | | | | |
| word17 | | | | | | | | | | | | | | | | | 2 | 2 | 0 | | | | | | | | | |
| word18 | | | | | | | | | | | | | | | | | | 2 | 0 | 1 | | | | | | | | |
| word19 | | | | | | | | | | | | | | | | | | | 0 | 1 | 2 | | | | | | | |
| word20 | | | | | | | | | | | | | | | | | | | | 1 | 2 | 1 | | | | | | |
| word21 | | | | | | | | | | | | | | | | | | | | | 2 | 1 | 2 | | | | | |
| word22 | | | | | | | | | | | | | | | | | | | | | | 1 | 2 | 2 | | | | |
| word23 | | | | | | | | | | | | | | | | | | | | | | | 2 | 2 | 1 | | | |
| word24 | | | | | | | | | | | | | | | | | | | | | | | | 2 | 1 | 1 | | |
| word25 | | | | | | | | | | | | | | | | | | | | | | | | | 1 | 1 | 0 | |
| word26 | | | | | | | | | | | | | | | | | | | | | | | | | | 1 | 0 | 0 |
| seq26 | 0 | 0 | 0 | 1 | 0 | 1 | 1 | 1 | 2 | 0 | 2 | 0 | 0 | 2 | 1 | 0 | 2 | 2 | 0 | 1 | 2 | 1 | 2 | 2 | 1 | 1 | | |

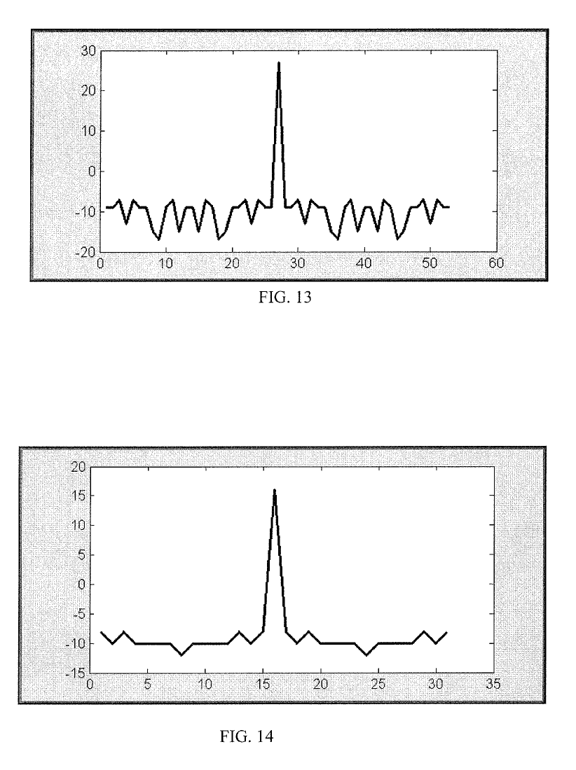

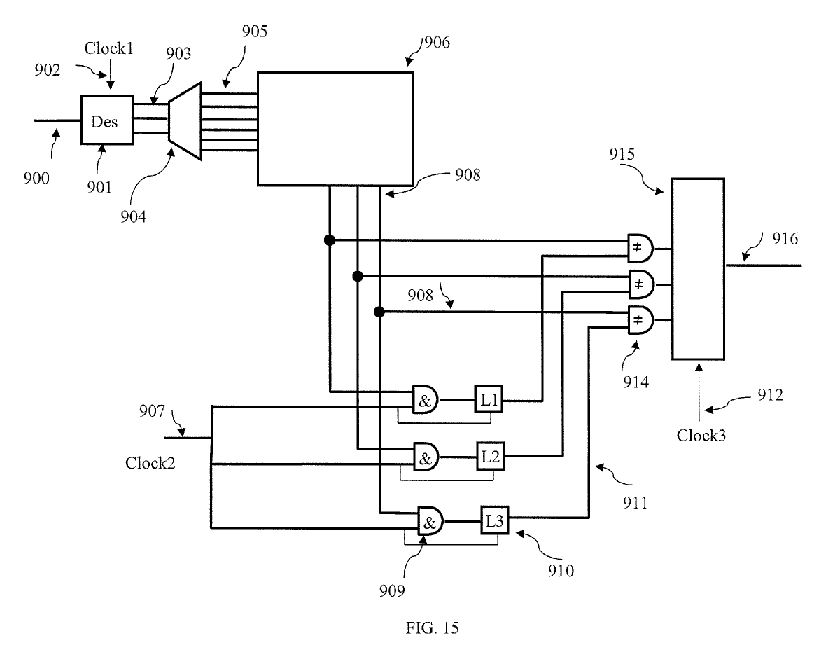

As an illustrative example the method can also be applied to generate ternary pseudo-noise like sequences of length 27 using 3-digit ‘word tables’, with no ‘forbidden’ word. One example is: [0 0 0 1 0 0 2 0 2 1 0 1 1 2 1 1 1 0 2 2 2 0 1 2 2 1 2]. Its auto-correlation graph is shown in FIG. 13.

The 4-Valued Case

The method can also be applied to generate 4-valued pseudo-random sequences. The 4-valued case (as well as other n-valued cases wherein n is not a prime number) for generating sequences in general receives special attention, as normal Galois Field approaches can no be applied and extended binary fields GF(2^{p}) have to be used.

As an illustrative example a 15-digits 4-valued sequence will be generated using 2-digit 4-valued ‘word tables’.

One 4-valued ‘word table’ is shown in the following table.

| address | | new1 | | new2 | | new3 | | new4 |
|---|---|---|---|---|---|---|---|---|
| 0 | 0 | 0 | 0 | 1 | 0 | 2 | 0 | 3 |
| 1 | 1 | 0 | 1 | 1 | 1 | 2 | 1 | 3 |
| 2 | 2 | 0 | 2 | 1 | 2 | 2 | 2 | 3 |
| 3 | 3 | 0 | 3 | 1 | 3 | 2 | 3 | 3 |

Each row in a 2-digit 4-valued ‘word table’ refers to 4 possible new addresses. Consequently each row can have 4!=12 different arrangements. And so there can be 12⁴ different 2-digit 4-valued ‘word tables’. Like before this way of using ‘word tables’ allows computerizing the generation of different 4-valued sequences of length 15. One can generate over 10,000 15 digit 4-valued sequences starting out from [3 3]. One of the 4-valued pseudo-random sequences with a bi-level auto-correlation graph with a single peak is [3 3 1 0 1 1 2 0 2 3 0 3 2 2 1].

It is also possible to generate 16 digit 4-valued pseudo-random like sequences. The method to generate these sequences will again not have a ‘forbidden’ word. Again thousands of 16 digit 4-valued sequences with very decent correlation properties can be generated. One of those is: [0 0 1 1 2 0 2 2 3 1 3 3 0 3 2 1]. Its auto-correlation graph is shown in FIG. 14.

It should be clear that the method can be expanded to 3-digit 4-valued word ‘word tables’ as well to p-digit 4-valued word ‘word tables’ with p an integer greater than 3.

The n-Valued Case

It should be clear that the method using n-valued ‘word tables’ using words of 2 digits or longer can be applied to generate n-valued pseudo-noise like sequences either of length n^{p} or of length (n^{p}−1). One can actually build the state machines using memory chips to generate the sequences, instead of using LFSRs. However it may be easier to determine the sequence, store it in a memory chip like an EPROM and have the chip being read out cyclically under control of a constant clock. In case of the non-binary sequences, the non-binary sequence elements or digits may be stored in binary form as binary words, of which the bits of the word are used as input signals to a D/A converter, which will generate the non-binary value of the signals.

Detection of Sequences

In applications such as spread-spectrum communications a complete (or part of a) pseudo-noise sequence usually represents a symbol such as a 0 or a 1 in the binary case. There are different ways to detect a complete sequence. A widely applied way is by correlation techniques. In the correlation method a local version of a sequence is generated and is compared to a received sequence. A correlation value between the two sequences determines when a sequence is supposed to be present. The correlation method of detection applies to binary and non-binary sequences.

Another method can be applied to binary and non-binary sequences which can be generated by an LFSR based sequence generator. It applies the corresponding LFSR descrambler to the LFSR based sequence generator. When a sequence that was generated by an LFSR based generator is descrambled by its corresponding descrambler a sequence of predominantly identical symbols is generated. This method was described in: U.S. Non-Provisional patent application Ser. No. 11/042,645, filed Jan. 25, 2005, entitled MULTI-VALUED SCRAMBLING AND DESCRAMBLING OF DIGITAL DATA ON OPTICAL DISKS AND OTHER STORAGE MEDIA and in U.S. Non-Provisional patent application, filed Feb. 25, 2005, entitled GENERATION AND DETECTION OF NON-BINARY DIGITAL SEQUENCES which both are incorporated herein by reference.

Memory Based Detection

A novel method to detect sequences, which is another aspect of the present invention, uses the ‘word table’ characteristics of the generated sequences. One aspect of the presented method to generate n-valued sequences with p-valued words is that the thus generated sequence contains only one instance of one particular n-valued word of p-digits. The same is true for n-valued words of length of q digits where q is greater than p. However there are more than 1 n-valued words of length of q digits when q is less than p in a sequence that is generated by a p-digit word method.

It is of course true that a whole pseudo-random sequence may be considered a unique word. Recognition of the sequence as a ‘complete’ word is not always practical. Also a small number of digit errors in the received sequence may cause non-detection. These aspects can be successfully addressed in detection methods such as correlation methods.

When it is possible to break up a sequence in smaller parts and to detect these parts, then one can set criteria to determine under what conditions of detecting sufficient parts in the right order will constitute ‘detection’ of the complete sequence.

In general one may assume that in a communication system applying sequences (such as spread-spectrum based systems) all sequences have the same length, they have a beginning and they have an end. All sequences when they are generated by the n-valued p-digit word method, apply the same words. And in each sequence each word will appear once when the word is of length p or greater (except the forbidden word if that applies). The different sequences can then be characterized by the order in which the different words appear in a sequence.

As an illustrative example the two binary 7-bits sequences generated by 3-bits word and [0 0 0] as forbidden word will be used. The two sequences are: s1=[1 1 1 0 1 0 0]

and

s2=[1 1 1 0 0 1 0].

The two 7-bits sequences can be created from 7 consecutive 3 bits words. It should be clear that an n^{p}−1 or an n^{p} length sequence can always be described with (n^{p}−1)−(p−1) or n^{p}−(p−1) words.

One embodiment of a detection circuit will use the word in a sequence as an address for a memory device. The memory will contain on that address a code which will assist in the detection. For instance the addresses in order of appearance of words can contain Gray Coded words. It is assumed that the sequence/words are synchronized on [1 1 1]. Further more any three consecutive digits are considered a word.

The two sequences s1 and s2 will then be coded into a memory device as shown in the following table.

| | sequence | | | | | | | | | | | | | | | |
|---|---|---|---|---|---|---|---|---|---|---|---|---|---|---|---|---|
| | 1 | 1 | 1 | 0 | 1 | 0 | 0 | | 1 | 1 | 1 | 0 | 0 | 1 | 0 | |
| | | | | | Gray | | | | | | | | Gray | | | |
| word1 | 1 | 1 | 1 | | | 0 | 0 | 0 | 1 | 1 | 1 | | | 0 | 0 | 0 |
| word2 | 1 | 1 | 0 | | | 0 | 0 | 1 | 1 | 1 | 0 | | | 0 | 0 | 1 |
| word3 | 1 | 0 | 1 | | | 0 | 1 | 1 | 1 | 0 | 0 | | | 0 | 1 | 1 |
| word4 | 0 | 1 | 0 | | | 0 | 1 | 0 | 0 | 0 | 1 | | | 0 | 1 | 0 |
| word5 | 1 | 0 | 0 | | | 1 | 1 | 0 | 0 | 1 | 0 | | | 1 | 1 | 0 |
| word6 | 0 | 0 | 1 | | | 1 | 1 | 1 | 0 | 1 | 1 | | | 1 | 1 | 1 |
| word7 | 0 | 1 | 1 | | | 1 | 0 | 1 | 1 | 0 | 1 | | | 1 | 0 | 1 |

The above table shows how the 3-bit words that constitute the sequences s1 and s2 can be used as a memory address. The memory then contains a Gray coded 3 bits word in order of appearance of the expected 3-bits words. This means that when a ‘detector’ receives the right sequence for which it is configured, then each consecutive word will generate a code that differs one bit with the previous one. So a detector device can be created that compares a code word (starting with the second word) with a previous word. The previous word to the second word is the first code word [0 0 0]. That means that correct detection of each word of the 7-bits sequence will generate 6 single bit differences. Assume that a difference of 1 bit between code words will generate a 1. If the difference is more than 1 bit a 0 will be generated. One can count the 1s. A count result of 6 indicates that the relevant 7-bits sequence was detected. As both sequences start with word [1 1 1] the related code word [0 0 0] may be used as an indication of synchronization and for instance reset the counter. The counter will not reach 6 when a detector receives a sequence for which it was not configured. Thus detection consists of counting single bit results, as a consequence of consecutive 3-bit words.

The following table shows the generated codes when the detector configured for s1 receives s2 and when a detector configured for s2 receives s1.

| | sequence | | | | | | | | | | | | | | | | | | | | | | | |
|---|---|---|---|---|---|---|---|---|---|---|---|---|---|---|---|---|---|---|---|---|---|---|---|---|
| | 1 | 1 | 1 | 0 | 1 | 0 | 0 | Δ | | | | Δ | 1 | 1 | 1 | 0 | 0 | 1 | 0 | Δ | | | | Δ |
| | | | | | correct1 | | | | wrong2 | | | | | | | | correct2 | | | | wrong1 | | | |
| word1 | 1 | 1 | 1 | | 0 | 0 | 0 | | 0 | 0 | 0 | | 1 | 1 | 1 | | 0 | 0 | 0 | | 0 | 0 | 0 | |
| word2 | 1 | 1 | 0 | | 0 | 0 | 1 | 1 | 0 | 0 | 1 | 1 | 1 | 1 | 0 | | 0 | 0 | 1 | 1 | 0 | 0 | 1 | 1 |
| word3 | 1 | 0 | 1 | | 0 | 1 | 1 | 1 | 1 | 0 | 1 | 1 | 1 | 0 | 0 | | 0 | 1 | 1 | 1 | 1 | 1 | 0 | — |
| word4 | 0 | 1 | 0 | | 0 | 1 | 0 | 1 | 1 | 1 | 0 | — | 0 | 0 | 1 | | 0 | 1 | 0 | 1 | 0 | 1 | 0 | 1 |
| word5 | 1 | 0 | 0 | | 1 | 1 | 0 | 1 | 0 | 1 | 1 | — | 0 | 1 | 0 | | 1 | 1 | 0 | 1 | 0 | 0 | 1 | — |
| word6 | 0 | 0 | 1 | | 1 | 1 | 1 | 1 | 0 | 1 | 0 | 1 | 0 | 1 | 1 | | 1 | 1 | 1 | 1 | 1 | 0 | 1 | 1 |
| word7 | 0 | 1 | 1 | | 1 | 0 | 1 | 1 | 1 | 1 | 1 | — | 1 | 0 | 1 | | 1 | 0 | 1 | 1 | 0 | 1 | 1 | — |
| | | | | | | | | 6 | | | | 3 | | | | | | | | 6 | | | | 3 |

The table shows the generated code when the s1 configured detector receives sequence s2 under columns ‘wrong2’. For correct detection this detector expects in consecutive order the words: [1 1 1], [1 1 0], [1 0 1], [0 1 0], [1 0 0], [0 0 1] and [0 1 1]. The detector will now receive these words in a different order which will form s2: [1 1 1], [1 1 0], [1 0 0], [0 0 1], [0 1 0], [0 1 1] and [1 0 1]. Consequently the generated code-words will be in a different order. Because a Gray code was used the difference between consecutive words will not be 1. When the distance is not 1, no signal will be generated. That means, as is shown in the table that when an incorrect sequence enters the detector a counter total of 3 is generated, while at correct detection a 6 will be generated. This is shown under the relevant column designated with ‘Δ’. The same result occurs when the detector configured for s2 receives s1.

It is not necessary to check for all words. Especially when the sequence is long enough it may be sufficient to check for instance for all non-overlapping words. For instance assume that 2 sequences of 16 bits have been generated by the 4-bits word method. Both words are synchronized and start with [1 1 1 1]. It may be sufficient to code and detect for 4-words, assuming that synchronization is guaranteed. (It should be clear that many different schemes and detection variants are possible, using the presence of non-repeating words in a sequence. The important aspect is that once a word has been detected in a sequence it will not occur a second time in that sequence.) This means also that two sequences do not need to start at the same word to be detected. However the words must be in significantly different order in two sequences to allow detection.

FIG. 15 shows a diagram of a circuit that will realize a single sequence detector. A binary sequence will be provided on input 900 to a deserializer 901, under control of a clock signal Clock1 provided on input 902. The deserializer 901 will change the incoming serial sequence into 3 parallel signals provided on outputs 903. The parallel signals are shifted one position at each clock pulse on 902. The clock speed is identical to the chip rate of the sequence provided on input 900. The 3 parallel signals on 903 are then provided to the inputs of an address decoder 904. Each parallel 3 bits word can activate a specific address line 905 in memory device 906. An activated address line enables the reading of the 3-bit memory content at that address. The read 3-bits are provided on 3 parallel outputs 908 of the memory device. These 3 parallel bits represent the 3-bit code words as described for the 7-bits sequence detector.

Presence of [0 0 0] can be used to initialize the detector, which is not shown in FIG. 15 to keep the diagram relatively simple. The purpose of the detector is to compare a code word with a previous code word. The circuit thus has to store a generated code word for at least one cycle. When a code word is generated it is stored in a register comprised of 3 memory elements L1, L2, and L3. Following the path of one bit provided on 908 one can see that the signal on 908 enters an AND gate 909 on a first input and a clock signal provided on 907 is provided on a second input of the AND gate. The same clock signal controls the memory element L3 910. Consequently when a new signal is provided on 908 it is written into a memory element L3 at 910 when a clock signal Clock2 provided on 907 is high. When Clock2 is low the content of the memory element L3 is provided on 911. The signal on 911 is provided on a first input of XOR device 914. A second input of device 914 provides the current signal on 908. So when the clock signals are correctly synchronized the signal generated on the output of XOR 914 is the result of the comparison of a current and a previous version of the signal on 908. There are different ways to achieve this. Instead of synchronizing clock signals it is also possible to make L1, L2, and L3 2 bit shift registers. The circuit should be realized in such a way that the output of the XOR devices compare a current signal on an output and the preceding signal on that output.

This comparison is done for all 3 parallel outputs of the memory device. When only one of the output signals of the 3 XOR devices is 1 then a circuit 915 under control of a clock signal Clock3 provided on 912 will update a counter by 1. When the counter reaches 6 a signal is provided on output 916 to indicate that a sequence was detected. The signal [0 0 0] may be used to reset the counter.

There are different coding ways to determine the presence of a sequence. One may use in fact any code that can distinguish between the order of received words. These codes do not have to be binary. They can be non-binary also. For instance non-binary Grey codes may be applied. While important to the selected and applied embodiments, the applied Gray coding is used as an illustrative example.

The method for detection as described works on all p-bit words formed by each consecutive series of p-bits from one bit in the sequence to the next. In fact for the p bit words the last (p−1) bits of a word are overlapping with the next word. The method can be modified to analyze non-overlapping words or words that have less than (p−1) digits overlapping. Such an approach lowers the number of steps needed to detect a sequence and it can lower the clock rate of a detection circuit.

By using the p-digit method and replace coding the words appropriately for the correct order, no replacement code word will be repeated in a sequence, no matter if words are overlapping or not. So if one is relatively confident about the quality of the received sequence (having a low Bit Error Ratio) it is not necessary to check for each word to achieve detection. One can easily skip overlapping words, or even use longer digit words than with p digits. It should be clear that words with less than p digits cannot be used for detection in all situations.

It should also be clear that transmission errors can affect the received words. If it is known what the BER is, one can take that into account in detecting sequences with errors. For instance if two words are affected by an error burst and the total sequence consists of 124 words, and 16 words can determine the sequence, then most likely also 14 words spread over the sequence can determine the presence of a sequence. One contemplated way to indicate the detection is by way of a probability number. For instance if 2 out of 14 detected words are in error one may say that the estimated chance that the correct sequence was detected is 14/16. This is clearly a very conservative estimate. The selected words are a sampling of the actual sequence. One can calculate (based on the channel characteristics) a much more accurate estimate. One can then determine the likelihood of other possible sequences to have occurred. In general one should select the to be used sequences in such a way that the probability of occurrence of a sampled sequence with errors against a reference sequence is higher than the probability of another sampled sequence against the same reference sequence. Accordingly it is one aspect of the present invention to use the word method for the detection of sequences with errors.

As an illustrative example of detection by words two 15 bits binary sequences created by the 4-bit word method will be used for a detection example. The following two sequences will be created and shown with the used words as well their related 4 bits Gray coding. One may use a different coding scheme like straight order numbering.

The following tables show how to create the two sequences.

| | b1 | b2 | b3 | b4 | | | | | | | | | | | | | | | Gray Code | | | | Δ |
|---|---|---|---|---|---|---|---|---|---|---|---|---|---|---|---|---|---|---|---|---|---|---|---|
| word1 | 1 | 1 | 1 | 1 | | | | | | | | | | | | | | | 0 | 0 | 0 | 0 | |
| word2 | | 1 | 1 | 1 | 0 | | | | | | | | | | | | | | 0 | 0 | 0 | 1 | 1 |
| word3 | | | 1 | 1 | 0 | 1 | | | | | | | | | | | | | 0 | 0 | 1 | 1 | 1 |
| word4 | | | | 1 | 0 | 1 | 0 | | | | | | | | | | | | 0 | 0 | 1 | 0 | 1 |
| word5 | | | | | 0 | 1 | 0 | 1 | | | | | | | | | | | 0 | 1 | 1 | 0 | 1 |
| word6 | | | | | | 1 | 0 | 1 | 1 | | | | | | | | | | 0 | 1 | 1 | 1 | 1 |
| word7 | | | | | | | 0 | 1 | 1 | 0 | | | | | | | | | 0 | 1 | 0 | 1 | 1 |
| word8 | | | | | | | | 1 | 1 | 0 | 0 | | | | | | | | 0 | 1 | 0 | 0 | 1 |
| word9 | | | | | | | | | 1 | 0 | 0 | 1 | | | | | | | 1 | 1 | 0 | 0 | 1 |
| word10 | | | | | | | | | | 0 | 0 | 1 | 0 | | | | | | 1 | 1 | 0 | 1 | 1 |
| word11 | | | | | | | | | | | 0 | 1 | 0 | 0 | | | | | 1 | 1 | 1 | 1 | 1 |
| word12 | | | | | | | | | | | | 1 | 0 | 0 | 0 | | | | 1 | 1 | 1 | 0 | 1 |
| word13 | | | | | | | | | | | | | 0 | 0 | 0 | 1 | | | 1 | 0 | 1 | 0 | 1 |
| word14 | | | | | | | | | | | | | | 0 | 0 | 1 | 1 | | 1 | 0 | 1 | 1 | 1 |
| word15 | | | | | | | | | | | | | | | 0 | 1 | 1 | 1 | 1 | 0 | 0 | 1 | 1 |
| seq | 1 | 1 | 1 | 1 | 0 | 1 | 0 | 1 | 1 | 0 | 0 | 1 | 0 | 0 | 0 | | | | | | | | |

For generating the second 15-bit sequence the following table and Gray coding can be applied.

| | b1 | b2 | b3 | b4 | | | | | | | | | | | | | | | Gray Code | | | | Δ |
|---|---|---|---|---|---|---|---|---|---|---|---|---|---|---|---|---|---|---|---|---|---|---|---|
| word1 | 1 | 1 | 1 | 1 | | | | | | | | | | | | | | | 0 | 0 | 0 | 0 | |
| word2 | | 1 | 1 | 1 | 0 | | | | | | | | | | | | | | 0 | 0 | 0 | 1 | 1 |
| word3 | | | 1 | 1 | 0 | 0 | | | | | | | | | | | | | 0 | 0 | 1 | 1 | 1 |
| word4 | | | | 1 | 0 | 0 | 0 | | | | | | | | | | | | 0 | 0 | 1 | 0 | 1 |
| word5 | | | | | 0 | 0 | 0 | 1 | | | | | | | | | | | 0 | 1 | 1 | 0 | 1 |
| word6 | | | | | | 0 | 0 | 1 | 0 | | | | | | | | | | 0 | 1 | 1 | 1 | 1 |
| word7 | | | | | | | 0 | 1 | 0 | 0 | | | | | | | | | 0 | 1 | 0 | 1 | 1 |
| word8 | | | | | | | | 1 | 0 | 0 | 1 | | | | | | | | 0 | 1 | 0 | 0 | 1 |
| word9 | | | | | | | | | 0 | 0 | 1 | 1 | | | | | | | 1 | 1 | 0 | 0 | 1 |
| word10 | | | | | | | | | | 0 | 1 | 1 | 0 | | | | | | 1 | 1 | 0 | 1 | 1 |
| word11 | | | | | | | | | | | 1 | 1 | 0 | 1 | | | | | 1 | 1 | 1 | 1 | 1 |
| word12 | | | | | | | | | | | | 1 | 0 | 1 | 0 | | | | 1 | 1 | 1 | 0 | 1 |
| word13 | | | | | | | | | | | | | 0 | 1 | 0 | 1 | | | 1 | 0 | 1 | 0 | 1 |
| word14 | | | | | | | | | | | | | | 1 | 0 | 1 | 1 | | 1 | 0 | 1 | 1 | 1 |
| word15 | | | | | | | | | | | | | | | 0 | 1 | 1 | 1 | 1 | 0 | 0 | 1 | 1 |
| seq | 1 | 1 | 1 | 1 | 0 | 0 | 0 | 1 | 0 | 0 | 1 | 1 | 0 | 1 | 0 | | | | | | | | |

Assume that each time a Gray coded word has a distance 1 from a previous word a 1 is added to a counter. When the distance is not 1 the counter stays the same (other schemes are possible). When the counter reaches 14 a sequence is detected. Decoding the non-corresponding sequence generates just a count of 6 and will lead to non-detection.

Gray coding of the words will still create situations wherein code distances are 1, when it is preferred they should not be. Another way of coding is to provide each word with a numerical code reflecting its absolute position in a sequence. Assume that a decimal code is given to each word, ranging from 0 to 14. The two sequences will be then coded as shown in the following tables.

| | b1 | b2 | b3 | b4 | Cd1 | Δ1 | Δ2 | Non | Δ1 | Δ2 | b1 | b2 | b3 | b4 | Cd2 | Δ2 | Non | Δ1 | Δ2 |
|---|---|---|---|---|---|---|---|---|---|---|---|---|---|---|---|---|---|---|---|
| word1 | 1 | 1 | 1 | 1 | 0 | | | 0 | | | 1 | 1 | 1 | 1 | 0 | | 0 | | |
| word2 | 1 | 1 | 1 | 0 | 1 | 1 | | 1 | 1 | | 1 | 1 | 1 | 0 | 1 | | 1 | 1 | |
| word3 | 1 | 1 | 0 | 0 | 2 | 1 | 2 | 7 | 0 | 6 | 1 | 1 | 0 | 1 | 2 | 2 | 10 | 9 | 9 |
| word4 | 1 | 0 | 0 | 0 | 3 | 1 | | 11 | 0 | | 1 | 0 | 1 | 0 | 3 | | 11 | 1 | |
| word5 | 0 | 0 | 0 | 1 | 4 | 1 | 2 | 12 | 1 | 5 | 0 | 1 | 0 | 1 | 4 | 2 | 12 | 1 | 2 |
| word6 | 0 | 0 | 1 | 0 | 5 | 1 | | 9 | 0 | | 1 | 0 | 1 | 1 | 5 | | 13 | 1 | |
| word7 | 0 | 1 | 0 | 0 | 6 | 1 | 2 | 10 | 1 | 0 | 0 | 1 | 1 | 0 | 6 | 2 | 9 | 0 | 0 |
| word8 | 1 | 0 | 0 | 1 | 7 | 1 | | 8 | 0 | | 1 | 1 | 0 | 0 | 7 | | 2 | 0 | |
| word9 | 0 | 0 | 1 | 1 | 8 | 1 | 2 | 13 | 0 | 3 | 1 | 0 | 0 | 1 | 8 | 2 | 7 | 5 | 0 |
| word10 | 0 | 1 | 1 | 0 | 9 | 1 | | 6 | 0 | | 0 | 0 | 1 | 0 | 9 | | 5 | 0 | |
| word11 | 1 | 1 | 0 | 1 | 10 | 1 | 2 | 2 | 0 | 0 | 0 | 1 | 0 | 0 | 10 | 2 | 6 | 1 | 0 |
| word12 | 1 | 0 | 1 | 0 | 11 | 1 | | 3 | 1 | | 1 | 0 | 0 | 0 | 11 | | 3 | 0 | |
| word13 | 0 | 1 | 0 | 1 | 12 | 1 | 2 | 4 | 1 | 2 | 0 | 0 | 0 | 1 | 12 | 2 | 4 | 1 | 0 |
| word14 | 1 | 0 | 1 | 1 | 13 | 1 | | 5 | 1 | | 0 | 0 | 1 | 1 | 13 | | 8 | 4 | |
| word15 | 0 | 1 | 1 | 1 | 14 | 1 | 2 | 14 | 0 | 10 | 0 | 1 | 1 | 1 | 14 | 2 | 14 | 6 | 10 |
| count | | | | | | 14 | 7 | | 6 | 1 | | | | | 14 | 7 | | 6 | 1 |

In the first situation the code is checked for each overlapping word (so on each one position shifted word). When the count is 14 a sequence is detected. The “wrong” sequence will generate a count of 7.

When it is assumed that one maintains synchronization (for instance the presence of word [1 1 1 1] in a 4-bits word created sequence) then it is possible to deserialize the incoming sequence in such a way that the next serialized word is created by shifting the incoming sequence by 2 positions. This means that a correct detection of a sequence generated by a corresponding generator will create a code wherein each detected word code is 2 higher than the previous code. This is indicated by the column under Δ2. When the sequence was not generated by the corresponding generator then the Δ2 is not 2 in almost every step. When a word is coded that is not part of the expected code then a 15 is generated. Further more a code that is lower than a previous code will generate a 0.

There are many ways to decode and to detect. By deserializing on a word, rather than on a digit basis one can decrease the clock rate for the detector. How much the clock rate can be decreased depends on the complexity of the decoding process and on how many words are required to detect or reject a sequence with sufficient confidence.

If a sequence is long enough it probably does not matter too much if actual synchronization is within one or two words of theoretical synchronization. For instance a 10-bit word pseudo-random ‘word method’ generates sequences of about 1000 bits. When deserializing takes place in non-overlapping steps of 10-bits words, one has to perform around 100 word detections. If one is confident about the 10 bit distance between words then the code difference between the consecutive words remains constant. Assuming that rejected words have a very low correct difference count, let's say perhaps 10 or 20 out of 100, then a difference of one word on a total of 99 correctly detected differences is negligible.

The advantage of the ‘memory based’ detection method is that it can run continuously. For long enough sequences it doesn't even matter if exact synchronization is lost. Assuming that all used sequences differ significantly is their order of words, loss of synchronization of even a word doesn't matter too much. A circuit can be created that will restore synchronization without losing information in the mean time. This is not possible with correlation techniques, where synchronization is usually essential.

As an illustrative example the method of detection according to an aspect of the present invention will be used to demonstrate it can also be applied to a 3-valued and consequently to any n-valued pseudo-noise like sequence generated by the p-digit word method, as any of the sequences can be formed from not repeated p-digit words.

As an illustrative example the 27 digit ternary pseudo-noise like sequences will be used, mainly because it is easier to split up in consecutive 3-digit words. The two 27 digits ternary sequences that will be used in this illustrative example are: ter1=[0 0 0 1 0 1 1 0 2 0 1 2 1 2 0 2 1 1 1 2 2 2 0 0 2 2 1] and ter2=[0 0 0 1 0 0 2 0 1 1 0 2 1 2 1 0 1 2 2 2 0 2 2 1 1 1 2].

When these sequences are decoded for at least 3-digit ternary words then a word will not repeat itself in the sequence. In this case non-overlapping words will be applied. The sequences ter1 and ter2 can be broken down and coded as shown in the following table. Next to the coding table a non-detect column will be shown wherein the coding for a non-corresponding sequence according to the rules of that coder will be shown. For non-expected words the decimal code 9 will be used. For simplicity a decimal code is applied. A ternary Gray code or other codes that reflect the absolute (or even relative) position of the expected word in a sequence can be used. The counter rules are as follows: when the next code is 1 higher than the preceding one a 1 is added. When this is not the case or when the code is a 9, 0 will be added.

| | | | | | non | | | | | non |
|---|---|---|---|---|---|---|---|---|---|---|
| | ter1 | | | code | detect | ter2 | | | code | detect |
| | 0 | 0 | 0 | 0 | 0 | 0 | 0 | 0 | 0 | 0 |
| | 1 | 0 | 1 | 1 | 9 | 1 | 0 | 0 | 1 | 9 |
| | 1 | 0 | 2 | 2 | 3 | 2 | 0 | 1 | 2 | 9 |
| | 0 | 1 | 2 | 3 | 5 | 1 | 0 | 2 | 3 | 2 |
| | 1 | 2 | 0 | 4 | 9 | 1 | 2 | 1 | 4 | 9 |
| | 2 | 1 | 1 | 5 | 9 | 0 | 1 | 2 | 5 | 3 |
| | 1 | 2 | 2 | 6 | 9 | 2 | 2 | 0 | 6 | 9 |
| | 2 | 0 | 0 | 7 | 9 | 2 | 2 | 1 | 7 | 8 |
| | 2 | 2 | 1 | 8 | 7 | 1 | 1 | 2 | 8 | 9 |
| counter | | | | 7 | 0 | | | | 7 | 0 |
| total | | | | | | | | | | |

Logic Based Detection

One aspect of the n-valued sequences generated by way of the p-digit n-valued word method is that within the sequence a p-digit word can only appear once. This forms the basis for the sequence detection according the memory based aspect of the present invention. The size of words for detection may be selected to contain more than p digits. However for this aspect of the present invention to work the word size may not be less than p n-valued digits.

One can apply a detection method that is another aspect of the present invention, which is based on executing logic functions. Assume that a binary system can receive one of 4 15 bits sequences, generated according to a 4-bits word method. The sequences are shown in the following table.

| | b1 | b2 | b3 | b4 | b5 | b6 | b7 | b8 | b9 | b10 | b11 | b12 | b13 | b14 | b15 |
|---|---|---|---|---|---|---|---|---|---|---|---|---|---|---|---|
| seq1 | 1 | 1 | 1 | 1 | 0 | 1 | 0 | 1 | 1 | 0 | 0 | 1 | 0 | 0 | 0 |
| seq2 | 1 | 1 | 1 | 1 | 0 | 0 | 0 | 1 | 0 | 0 | 1 | 1 | 0 | 1 | 0 |
| seq3 | 1 | 1 | 1 | 1 | 0 | 1 | 0 | 0 | 1 | 0 | 1 | 1 | 0 | 0 | 0 |
| seq4 | 1 | 1 | 1 | 1 | 0 | 0 | 1 | 0 | 1 | 1 | 0 | 1 | 0 | 0 | 0 |

Assume that all 4 sequences are sent in sync, meaning that all start with [1 1 1 1 ]. This is not essential to the detection method but makes it easier to see how one can distinguish between sequences by having a common synchronization point. Assume that the sequence ‘seq1’ needs to be detected.

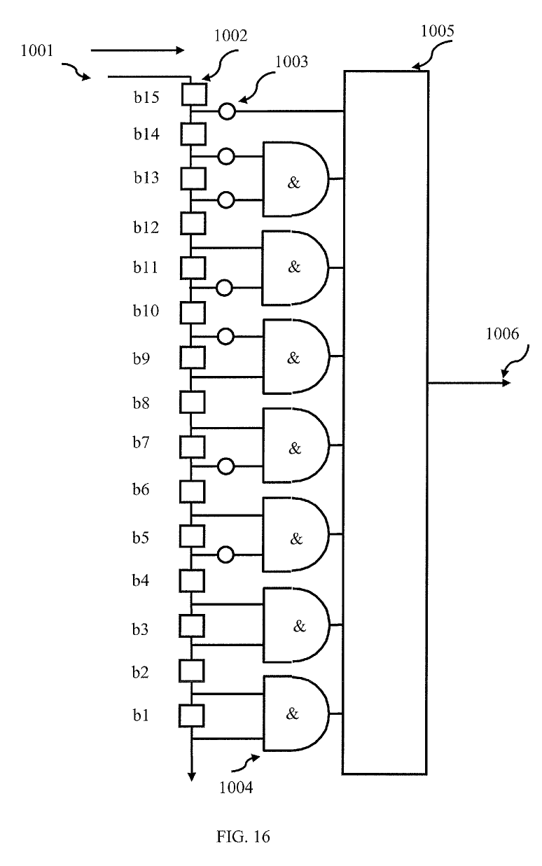

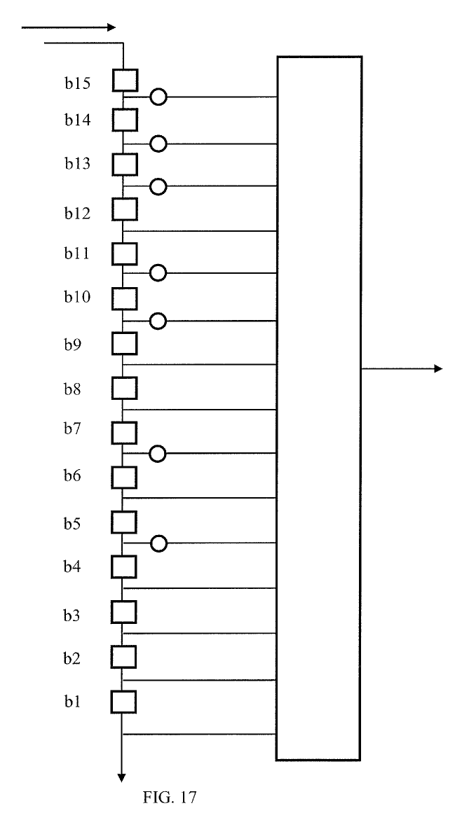

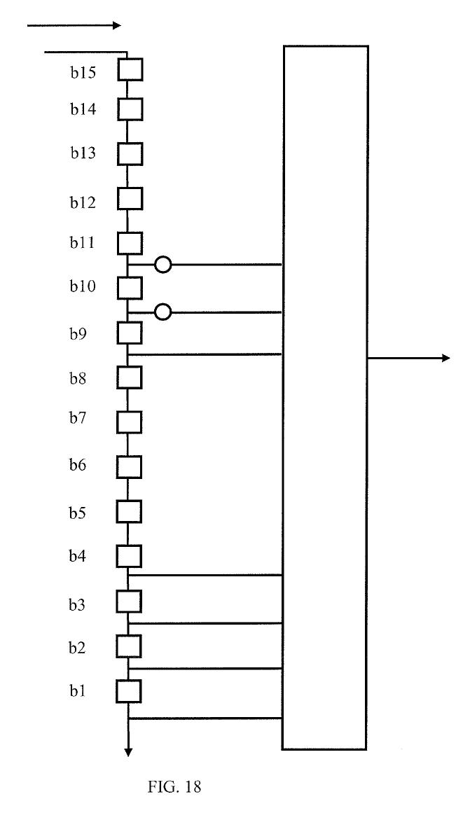

One way to detect ‘seq1’ among the 4 (in sync) sequences ‘seq1’, ‘seq2’, ‘seq3’ and ‘seq4’ is to put the sequences through a shift register and check the outputs of the elements of the shift register against a known output. For instance the diagram of FIG. 16 shows a circuit where the outputs of the ‘AND’ functions and the single output will all generate a 1 when ‘seq1’ is present in the shift register. The sequence is inputted on input 1001 in FIG. 16 and clocked on each clock pulse through the complete shift register. Inverters like 1003 help create a 1 when a 0 is expected. All 15 output signals are provided to a decision circuit 1005 that will determine if 15 signals 1 are present. If that is the case then for instance a signal 1 will provided on output 1006 to indicate that a certain sequence has been detected.

One aspect of the present invention is to generalize the described approach, which is shown in FIG. 17. Herein any sequence of 15 digits is clocked (clock not shown) into an n-valued shift register. The outputs of the element of the shift register can be modified by reversible n-valued inverters such that for instance all 1s or all 2s are entered into a decision circuit.

The disadvantage of the approach of entering all digits of a sequence into a shift register is first of all a potential problem of power consumption at a high clock rate. Further more the presence of a sequence should be established within one clock cycle, which may be a problem.

In the illustrative example there is sufficient information about the sequences to determine the sequence based on the synchronization point e.g. [b1 b2 b3 b4]=[1 1 1 1] and [b9 b10 b11]=[1 0 0]. Only sequence ‘seq1’ of the 4 sequences meets these conditions. Such approach shown in FIG. 18 will limit the complexity of the decision circuitry.

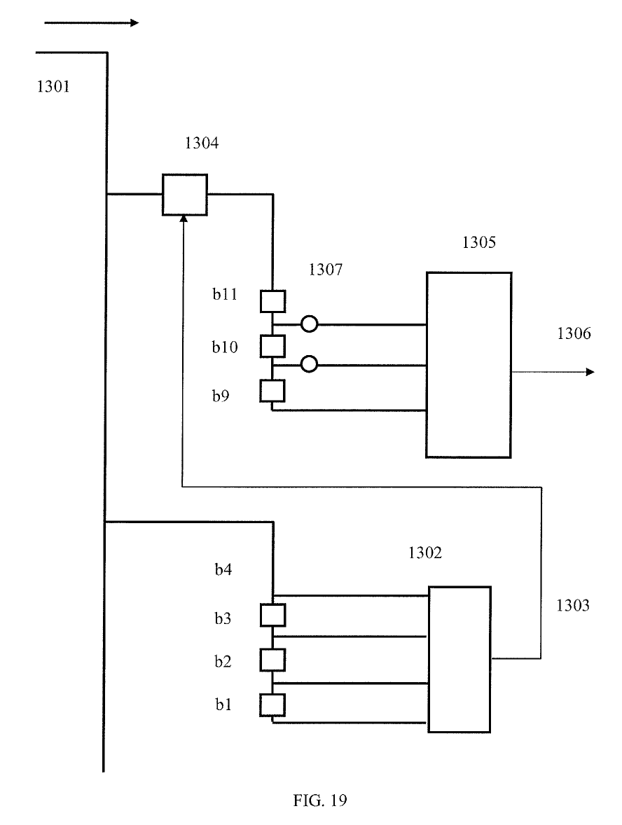

In order to limit the number of shift register elements and the time that all elements are active the method as shown in FIG. 19 is another aspect of the present invention. To establish a point of synchronization the shift register elements [b1 b2 b3 b4] will be active all the time and all digits of the sequence are shifted through these elements. As soon as [b1 b2 b3 b4]=[1 1 1 1] there is an opportunity that sequence ‘seq1’ can be detected. The actual detection depends on the status of [b9 b10 b11] (which has to be [1 0 0]. Until [b1 b2 b3 b4] was [1 1 1 1] the shift register elements 1307 have been disconnected by a gating device 1304 from the incoming data stream. When [b1 b2 b3 b4] is [1 1 1 1] the detection device 1302 generates an enabling signal on output 1303 which is provided to gating device 1304. Gating device 1304, after receiving the enabling signal, will then sample (4 clock pulses after the enabling signal) for three clock cycles elements of the sequence into the shift register 1307. When sequence ‘seq1’ is present then the content of [b9 b10 b11] will be [1 0 0]. When that is the case decision circuit 1305 will generate a ‘sequence detected’ signal on output 1306. This approach allows limiting the amount of active circuitry, required components and power consumption. It also alleviates time critical bottle necks in the decision circuitry. A reset signal may be used to re-initialize all circuits after detection.

This approach can be used for binary as well as non-binary detection.

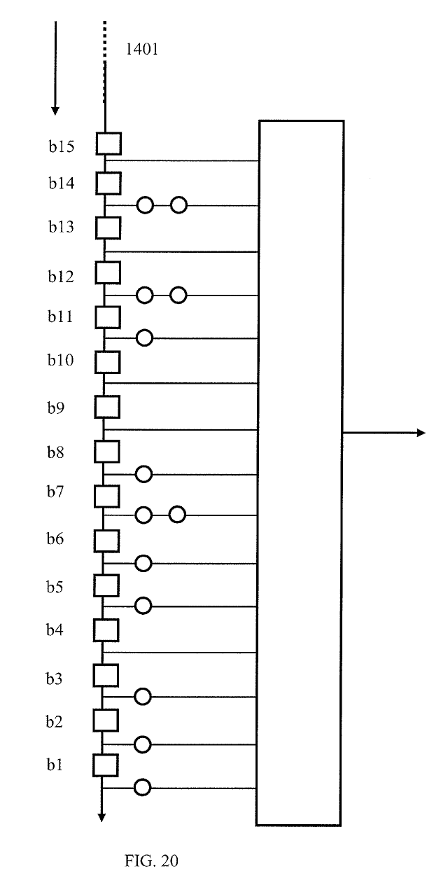

As an illustrative example the detection of the first 15 digits of ternary sequence ter2=[0 0 0 1 0 0 2 0 1 1 0 2 1 2 1 0 1 2 2 2 0 2 2 1 1 1 2] is shown in FIG. 20. The first 15 digits are: [0 0 0 1 0 0 2 0 1 1 0 2 1 2 1 . . . ]. When an output 1 is desired when the relevant digit is detected then inverters should be used got transforming a 0 to 1 and an inverter for transforming a 2 to a 1. The universal ternary inverter [1 2 0] transforms a 0 into a 1. Applying the inverter twice transforms a 2 into a 1.

Pseudo-noise sequences created by using the word method, wherein each word has p n-valued symbols, will contain each word only once. If the sequence is truly pseudo random it will contain each word of p symbols exactly once. It should be clear that one can create in a sequence of k n-valued symbols (by overlap) also k words of q n-valued symbols wherein q>p. In that case each word of q n-valued symbols will appear at maximum only once. But it is not certain that a word of q n-valued symbols will actually appear in the k symbol sequence. One can of course use the q n-valued words for detection.

In the present invention a distinction is made between binary, 3-valued, 4-valued and n-valued symbols in general. The aspects of the present invention also apply to n-valued symbols which are expressed as words of p-valued symbols and wherein p<n. Most common would probably be a translation of n-valued symbols into binary symbols. One should take into account that in order to express an n-valued symbol into p-valued symbols will take more than a single p-valued symbol. Thus the “overlap” of symbols in an n-valued base will need to be replaced by a p-valued word overlap approach and one should be careful to maintain the synchronization of the p-valued words.

It should be clear to those skilled in the art that pn-sequences have many applications and that the use of the binary and n-valued sequences that can be generated by the here invented method is not limited to the examples provided. The aspects of the present invention in generating and detecting sequences can have wide applications. They can be applied in virtually all applications where also LFSRs and correlation methods are used related to sequences. Applications in spread-spectrum, wireless and UWB communications are contemplated. Pseudo-noise type sequences are widely used in self testing of electronic circuits and systems. This type of application is generally known as built-in self-test (BIST). At certain high-speed applications one would like to limit the number of test-steps of BIST for instance to limit power consumption or overheating of circuits. The methods which are an aspect of the present invention can reduce clock-rates of sequence generation as well as sequence detection.

Further more it should be clear that there are many ways to apply the methods of the present invention to create sequence generators that will generate or detect the binary and non-binary sequences. A general programmable micro-processor may be used, assisted by D/A converters. Dedicated digital circuitry either of binary or non-binary nature may be used. The generated sequences can be of electrical or optical nature or of any physical nature that can express or represent a binary or n-valued transition, such as colors, symbols or physical states. Sequences can be generated off-line automatically or manually and captured in a memory element or data storage element for later (real-time) use. In view of the above description of the present invention, it will be appreciated by those skilled in the art that many variations, modifications and changes can be made to the present invention without departing from the spirit or scope of the present invention as defined by the claims appended hereto. All such variations, modifications or changes are fully contemplated by the present invention. While the invention has been described with reference to an illustrative embodiment, this description is not intended to be construed in a limiting sense.

The following patent applications, including the specifications, claims and drawings, are hereby incorporated by reference herein, as if they were fully set forth herein: (1) U.S. Non-Provisional patent application Ser. No. 10/935,960, filed on Sep. 8, 2004, entitled TERNARY AND MULTI-VALUE DIGITAL SCRAMBLERS, DESCRAMBLERS AND SEQUENCE GENERATORS; (2) United States Non-Provisional patent application Ser. No. 10/936,181, filed Sep. 8, 2004, entitled TERNARY AND HIGHER MULTI-VALUE SCRAMBLERS/DESCRAMBLERS; (3) U.S. Non-Provisional patent application Ser. No. 10/912,954, filed Aug. 6, 2004, entitled TERNARY AND HIGHER MULTI-VALUE SCRAMBLERS/DESCRAMBLERS; (4) U.S. Non-Provisional patent application Ser. No. 11/042,645, filed Jan. 25, 2005, entitled MULTI-VALUED SCRAMBLING AND DESCRAMBLING OF DIGITAL DATA ON OPTICAL DISKS AND OTHER STORAGE MEDIA; (5) U.S. Non-Provisional patent application Ser. No. 11/000,218, filed Nov. 30, 2004, entitled SINGLE AND COMPOSITE BINARY AND MULTI-VALUED LOGIC FUNCTIONS FROM GATES AND INVERTERS; (6) U.S. Non-Provisional patent application Ser. No. 11/065,836 filed Feb. 25, 2005, entitled GENERATION AND DETECTION OF NON-BINARY DIGITAL SEQUENCES; (7) U.S. Non-Provisional patent application Ser. No. 11/139,835 filed May 27, 2005, entitled MULTI-VALUED DIGITAL INFORMATION RETAINING ELEMENTS AND MEMORY DEVICES.

1. A method for generating a sequence having k n-valued symbols from k different words of p n-valued symbols with k, p and n being integers 2 or greater, comprising:
a) selecting a first word from the k different words;
b) selecting a second word from the k different words that have not been selected in such a manner that the first (p−1) symbols of the second word are identical to the last (p−1) symbols of the first word;
c) assigning a first symbol of the first word as a next symbol in the sequence;
d) assigning the second word to be the first word; and
e) repeating step b) to d) until all k words have been selected once;
f) wherein an LFSR is not used.

2. The method as claimed in claim 1, wherein the steps are executed by a computer program.

3. The method as claimed in claim 1, wherein n=2 and k=(2^{p}−1).

4. The method as claimed in claim 1, wherein n=2 and k=(2^{p}).

5. The method as claimed in claim 1, wherein n≠2 and k=(n^{p}−1).

6. The method as claimed in claim 1, wherein n≠2 and k=(n^{p}).

7. The method as claimed in claim 1, wherein the sequence is a pseudo-noise sequence.

8. A method for comparing a first sequence having k n-valued symbols and which can be decomposed into k different words of p n-valued symbols, with a second sequence having not more than k symbols comprising:
selecting m words of p symbols from the second sequence and determining an order of the m words;
determining whether the m words are present in the first sequence;
determining an order of the m words in the first sequence if they are present; and
deciding that the second sequence is identical to the first sequence when the m words appear in the first and the second sequence in an identical order.

9. The method as claimed in claim 8, wherein the m words are a sample of the second sequence.

10. The method as claimed in claim 8, wherein the second sequence is from a plurality of different sequences each having k n-valued symbols wherein each sequence can be decomposed into k different words of p n-valued symbols.

11. The method as clamed in claim 8, wherein errors may have occurred in the second sequence and a measure of similarity between the first sequence and the second sequence is provided by a probability number.

12. The method as claimed in claim 8, wherein the steps of the method are executed by a computer program.

13. An apparatus for comparing a first sequence having k n-valued symbols and which can be decomposed into a plurality of k different words of p n-valued symbols with a second sequence having not more than k symbols comprising:
a processor;
a device that outputs a representation of the first sequence to the processor;
an input for inputting the second sequence to the processor;
application software operable on the processor to process data representing the first and the second sequence, including:
selecting m words of p symbols from the second sequence and
determining a relative order of the m words in the second sequence;
determining whether the m words are present in the first sequence;
determining an order of the m words in the first sequence if they are present; and
deciding that the second sequence is identical to the first sequence when the m words appear in the first and the second sequence in an identical order.

14. The apparatus as claimed in claim 13, wherein the m words are a sample of the second sequence.

15. The apparatus as claimed in claim 13, wherein the second sequence is from a plurality of different sequences having k n-valued symbols wherein each sequence can be decomposed into k different words of p n-valued symbols.

16. The apparatus as claimed in claim 13, wherein errors may have occurred in the second sequence and a measure of similarity between the first sequence and the second sequence is provided by a probability number.

17. The apparatus as claimed in claim 13, wherein the apparatus is part of a wireless device.

18. The apparatus as claimed in claim 13, wherein the apparatus is part of a device connected to a communication line.

19. The apparatus as claimed in claim 13, wherein the apparatus is part of a UWB device.
